(19) United States
(12) Patent Application Publication
(10) Pub. No.: US 2010/0009217 A1
(43) Pub. Date: Jan. 14, 2010

(54) TRANSFER MOLD FOR MANUFACTURING RECORDING MEDIUM

(76) Inventors: Yasuo Hosoda, Saitama (JP); Osamu Kasono, Saitama (JP); Takahiro Umada, Kanagawa (JP)

Correspondence Address: DRINKER BIDDLE & REATH (DC), 1500 K STREET, N.W., SUITE 1100, WASHINGTON, DC, 20005-1209, US

(21) Appl. No.: 12/518,420

(22) PCT Filed: Dec. 13, 2006
(86) PCT No.: PCT/JP2006/324851

§ 371 Date: Jul. 28, 2009

(51) Int. Cl. B29C 59/00; G11B 5/00

(52) U.S. Cl. 428/800; 425/470; 264/293

(57) ABSTRACT

A transfer mold for manufacturing a recording medium by imprinting, having a transfer surface on which a data area having a data track pattern for a disk-shaped recording medium and a dummy area having a dummy pattern in an outward portion and/or an inward portion of the data area are formed. The dummy pattern includes at least one line of a plurality of dummy protrusions that have a width in a disk radial direction of no less than a track pitch of the data track pattern.

### TECHNICAL FIELD

The present invention relates to a recording medium manufacturing transfer mold having a transfer surface on which a pattern to be transferred by pressing onto a surfaces of a recording medium substrate when manufacturing recording mediums is formed.

### BACKGROUND ART

On a magnetic disk used in a hard disk drive (HDD), as shown in FIG. 1, servo areas on which a servo pattern used to detect positions of tracks on the magnetic disk relative to a magnetic head is recorded, and data areas on which a pattern of tracks for data recording and reproducing is formed are alternately arranged at constant angular intervals along circumferential tracks, and hence the magnetic head can detect recording or reproducing positions at constant time intervals during data recording or reproducing.

When manufacturing magnetic disks having patterns of the servo areas and data areas, using magnetic disk substrates having a surface on which a resin layer as a mold receiving layer is formed, an imprinting process is performed where pressure is applied onto the resin layer on the surface of the substrate with a transfer mold (stamper). By the imprinting process, recesses and protrusions of the patterns of the servo areas and data areas are transferred into the resin layer, and in subsequent processes, magnetic disks are produced in accordance with the substrates having the patterns transferred thereon.

In the imprinting process, if a transfer mold where guard bands between tracks of the data areas are formed by protrusions is used, the problem occurs that protrusions in the outer and inner circumference portions of the data areas transferred in the resin layer are bent due to imprinting pressure application, resulting in a deformation of the pattern. Specifically, as shown in FIG. 2A, when a transfer mold 51 is pressed onto a resin layer 53 on a substrate 52 in the direction of the arrows by imprinting pressure application, the transfer mold 51 is distorted by biting obliquely into the layer, and when stopping pressure application and moving back the transfer mold to be separated from the resin layer 53, as shown in FIG. 2B, the transfer mold 51 bends protrusions formed in the resin layer 53 as if it pulls them in the direction of the arrows, resulting in a deformation of the pattern.

In Japanese Patent Application Laid-Open Publication No. 2005-71487, there is disclosed a method for dealing with this problem wherein protrusions for dispersing pressure applied by imprinting are formed outward and inward of an annular area of a transfer mold where a recess/protrusion pattern can be formed. In Japanese Patent Application Laid-Open Publication No. H06-212457, there is disclosed a method, although an object is different, wherein a spiral dummy groove pattern equivalent to a groove pattern of the data area is provided in a transfer mold to make etching depth uniform in the data area of the product obtained by patterning. In Japanese Patent Application Laid-Open Publication No. 2001-118284, there is disclosed a method wherein dummy grooves or dummy pits are provided outward of an information area in a magneto-optical disk stamper.

### DISCLOSURE OF THE INVENTION

However, in the methods disclosed in the Japanese Patent Application Laid-Open Publications, a dummy recess/protrusion pattern equivalent in shape to a pattern formed in a data area is simply provided inward and outward of the data area in a transfer mold, and thus there is a problem that these methods do not effectively prevent the deformation of the pattern of the data area formed in the resin layer by imprinting pressure application. That is, because the dummy pattern area is set based on the premise that when the transfer mold is pressed onto the resin layer by imprinting pressure application, the transfer mold is distorted by biting obliquely into the layer, as the pressure application is repeated, the deformation of the dummy pattern transferred in the resin layer grows to affect guard bands in the data area before long.

Accordingly, one of problems to be solved by the invention is the above problem, and an object of the present invention is to provide a transfer mold for manufacturing a recording medium, a recording medium manufacturing method using the same, and a recording medium manufactured using the same that can reliably prevent the deformation of the pattern of the data area formed in a mold receiving layer such as a resin layer by imprinting pressure application.

A recording medium manufacturing transfer mold of the invention according to claim 1 is a transfer mold for manufacturing a recording medium by imprinting, having a transfer surface on which a data area having a data track pattern for a disk-shaped recording medium and a dummy area having a dummy pattern in an outward portion and/or an inward portion of the data area are formed, wherein the dummy pattern includes at least one line of a plurality of dummy protrusions that have a width in a disk radial direction of no less than a track pitch of the data track pattern.

A recording medium manufacturing method of the invention according to claim 7 is a recording medium manufacturing method of pressing onto a mold receiving layer formed on a surface of a recording medium substrate a transfer surface of a recording medium manufacturing transfer mold which has the transfer surface on which a data area having a data track pattern for a disk-shaped recording medium and a dummy area having a dummy pattern in an outward portion and/or an inward portion of the data area are formed, to transfer the data track pattern and the dummy pattern into the mold receiving layer, wherein the dummy pattern includes at least one line of a plurality of dummy protrusions that have a width in a disk radial direction of no less than a track pitch of the data track pattern.

A recording medium of the invention according to claim 8 is a recording medium produced in accordance with a data track pattern and a dummy pattern transferred in a mold receiving layer formed on a surface of a recording medium substrate by pressing onto the mold receiving layer a transfer surface of a recording medium manufacturing transfer mold which has the transfer surface on which a data area having a data track pattern for a disk-shaped recording medium and a dummy area having a dummy pattern in an outward portion and/or an inward portion of the data area are formed, wherein the dummy pattern includes at least one line of a plurality of dummy protrusions that have a width in a disk radial direction of no less than a track pitch of the data track pattern.

### BRIEF DESCRIPTION OF DRAWINGS

FIG. 1 shows data areas and servo areas formed on a magnetic disk;

FIGS. 2A and 2B show a state when imprinting with a transfer mold;

FIG. 3 shows a transfer surface of a transfer mold according to the present invention;

FIG. 4 shows in enlarged view a part of the outer circumference side of the transfer surface of the transfer mold of FIG. 3;

FIG. 5 shows schematically a configuration of an imprinting apparatus;

FIG. 6 shows a state when imprinting with the transfer mold of FIG. 3;

FIG. 7 shows in enlarged view a part of the outer circumference side of a transfer surface of a transfer mold as another embodiment of the present invention;

FIG. 8 shows in enlarged view a part of the outer circumference side of a transfer surface of a transfer mold as another embodiment of the present invention;

FIG. 9 shows in enlarged view a part of the outer circumference side of a transfer surface of a transfer mold as another embodiment of the present invention;

FIG. 10 shows in enlarged view a part of the outer circumference side of a transfer surface of a transfer mold as another embodiment of the present invention;

FIG. 11 shows in enlarged view a part of the outer circumference side of a transfer surface of a transfer mold as another embodiment of the present invention;

FIG. 12 shows in enlarged view a part of the outer circumference side of a transfer surface of a transfer mold as another embodiment of the present invention;

FIG. 13 shows in enlarged view a part of the outer circumference side of a transfer surface of a transfer mold as another embodiment of the present invention;

FIG. 14 shows in enlarged view a part of the outer circumference side of a transfer surface of a transfer mold as another embodiment of the present invention;

FIG. 15 shows in enlarged view a part of the outer circumference side of a transfer surface of a transfer mold as another embodiment of the present invention;

FIG. 16 shows in enlarged view a part of the outer circumference side of a transfer surface of a transfer mold as another embodiment of the present invention;

FIGS. 17A and 17B show a transfer surface of a transfer mold as another embodiment of the present invention;

FIGS. 18A to 18M show process steps of a method of manufacturing magnetic disks by transfer using the transfer mold of FIG. 3; and

FIGS. 19A to 18K show process steps of another method of manufacturing magnetic disks by transfer using the transfer mold of FIG. 3.

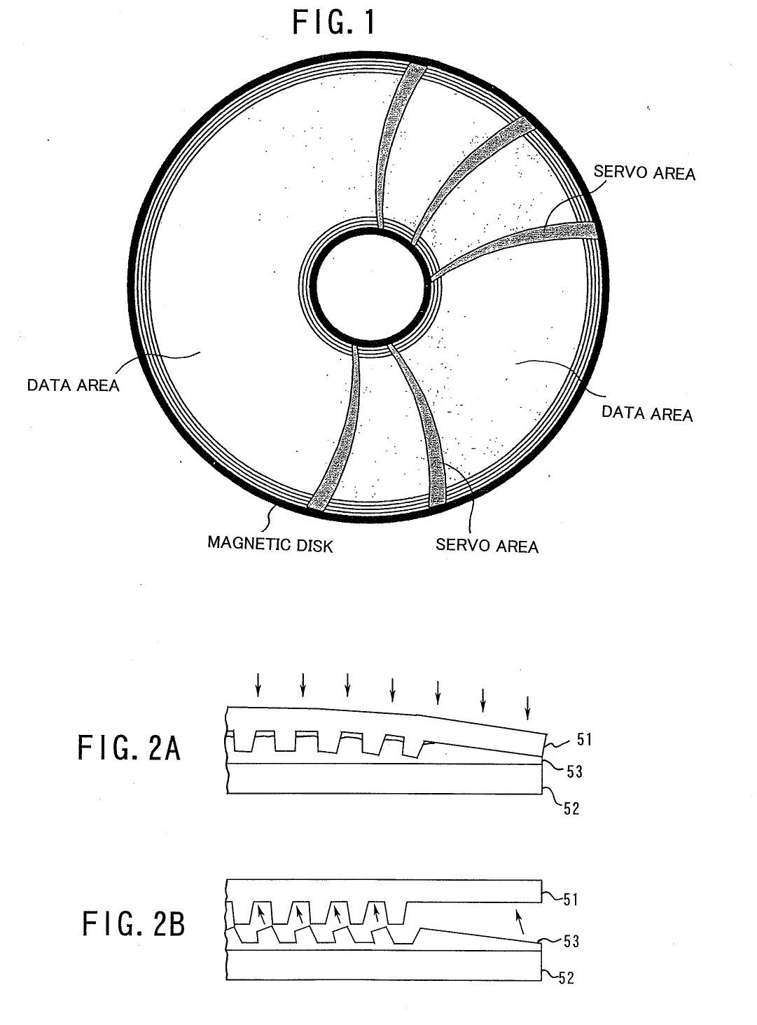

### BEST MODE FOR CARRYING OUT THE INVENTION

In the recording medium manufacturing transfer mold of the invention according to claim 1, the recording medium manufacturing method of the invention according to claim 7, and the recording medium of the invention according to claim 8, a dummy pattern of a dummy area comprises at least one line of multiple dummy protrusions that have a width in a disk radial direction of no less than the track pitch of a data track pattern of a data area, and hence when the transfer mold is pressed onto a mold receiving layer on a substrate surface by an imprinting apparatus, the dummy area portion of the transfer mold is prevented from being distorted. Hence, the patterns of both the dummy area and the data area can be reliably transferred into the mold receiving layer on the substrate surface without deformation. Thus, recording media having a highly accurate data track pattern can be manufactured at low cost. Further, areas which cannot be used for the data area can be reduced in the recording medium.

### Embodiments

Embodiments of the present invention will be described in detail below with reference to the drawings.

The transfer mold to which the present invention is applied is made of, e.g., metal material such as Ni, metalloid material such as Si, or light transmissive material such as an oxide of metal or metalloid, e.g., SiO₂. The transfer mold is preferably produced using an electron beam lithography apparatus capable of forming a highly accurate pattern. Specifically, using an x-θ electron beam lithography apparatus that has a mechanism for moving a substrate horizontally and a rotating stage for rotating the substrate and irradiates an electron beam onto a resist coated on the substrate for lithography, as the substrate is rotated and at the same time moved in a radial direction, an electron beam modulated according to a desired lithography pattern (including a data track pattern for the data area, a servo pattern for the servo area, a dummy pattern for the dummy area, and the like) writes the lithography pattern into the resist, and after development, etching, plating, etc., are performed to produce the transfer mold. The above desired lithography pattern will be described in detail later.

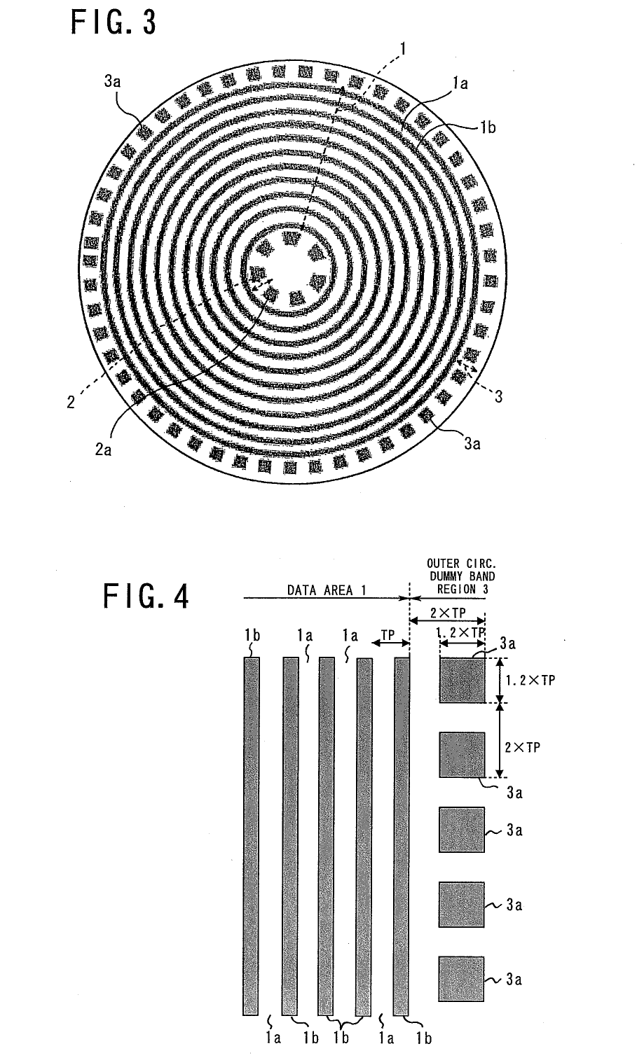

FIG. 3 shows the transfer surface of the transfer mold to which the present invention is applied. FIG. 4 shows in enlarged view a part of the outer circumference side of the transfer surface of the transfer mold of FIG. 3. On this transfer surface of the transfer mold, a data area 1, and an inner circumference dummy band region 2 and an outer circumference dummy band region 3 that are dummy areas are formed annularly. The data area 1 is formed between the inner and outer circumference dummy band regions 2, 3, and comprises a plurality of concentric circular recessed tracks 1a and protruding guard bands 1b between the tracks. In the inner and outer circumference dummy band regions 2, 3 respectively, a plurality of dummy protrusions 2a and 3a are arranged at predetermined intervals. Each of the dummy protrusions 2a and 3a is shaped in a square as viewed from the front of the transfer surface. The height of the dummy protrusions 2a and 3a is the same as that of the guard bands 1b.

Assuming that the track pitch of the tracks 1a is expressed by TP. Then the length Y1 of one side of the square of the dummy protrusion 3a needs to be approximately TP or greater and in this embodiment, is 1.2*TP as shown in FIG. 4. The pitch of the dummy protrusions 3a in a track tangential direction is 2*TP. The pitch of the outermost guard band 1b of the data area 1 and the dummy protrusion 3a is 2*TP. The length Y2 of the space between adjacent dummy protrusions 3a is given as Y2=2*TP−1.2*TP=0.8*TP. In addition, there is the relationship that Y2<Y1. These arrangement settings of the dummy protrusions 3a also apply to the dummy protrusions 2a.

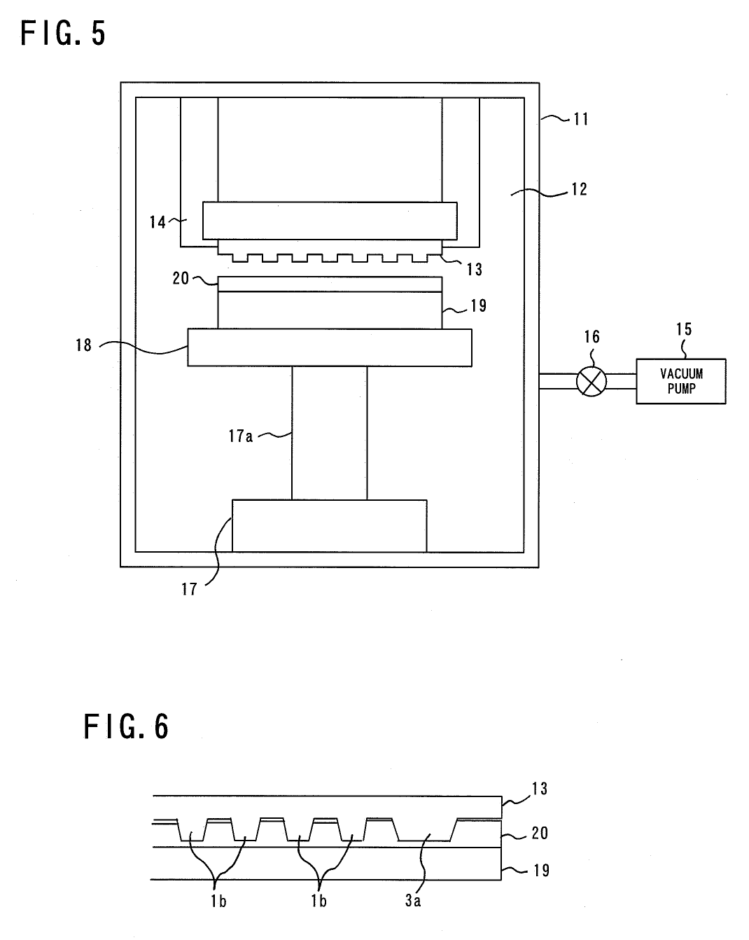

FIG. 5 shows schematically the configuration of an imprinting apparatus that uses the transfer mold of FIG. 3. In this imprinting apparatus, an operation chamber 12 is formed in an apparatus housing 11, and the imprinting apparatus body is placed therein. A transfer mold holding unit 14 that holds a transfer mold 13 with the transfer surface facing downward is secured to the upper part inside the apparatus housing 11. The transfer mold 13 is the same as shown in FIGS. 3 and 4.

A lifting pressure applying unit 17 is secured to the lower part inside the apparatus housing 11. The lifting pressure applying unit 17 moves up and down a table 18 provided on the top of a movable portion 17a thereof. The up and down movement of the table 18 by the lifting pressure applying unit 17 is controlled by a controlling device (not shown). A substrate 19 is placed on the table 18. On the surface of the substrate 19, there is formed a resin layer 20 that is a mold receiving layer into which a pattern is to be transferred. The resin layer 20 is made of, e.g., polymethyl methacrylate resin that has flowability at room temperature or when heated to glass transition temperature or higher. The surface of the resin layer 20 on the substrate 19 faces the transfer mold 13. When the lifting pressure applying unit 17 lifts the table 18 together with the substrate 19, the transfer mold 13 is pressed onto the resin layer 20 by pressure application from the lifting. As shown in, e.g., FIG. 6, the guard bands 1b and dummy protrusions 3a of the transfer mold 13 are pressed into the resin layer 20, and thereby the pattern of the transfer mold 13 is transferred into the resin layer 20.

A vacuum pump 15 is provided to decrease pressure in the operation chamber 12 inside the apparatus housing 11 via an adjusting valve 16 when imprinting with the transfer mold 13. This is for preventing the occurrence of bubbles between the transfer mold 13 and the resin layer 20 and removing gas issuing from the resin layer 20 due to heating and cure reaction.

In imprinting by the imprinting apparatus, it is desirable that the thickness of extra resin left at the bottoms of the recesses of the resin layer 20 after transferring be uniform, and hence it is desirable that the pattern-to-space area ratio of the data area 1 be kept in the dummy band regions 2, 3 as well. For example, if the ratio of the width of the guard band 1b to the width of the track 1a=40%:60%, it is desirable that the dummy protrusions 2a, 3a be 1.2 to 1.3 track pitches wide in side and arranged at pitches of 2 track pitches wide.

In the case of a pattern feature such as an isolated dot or line, if the pattern feature is, e.g., 90 nm wide and 60 nm high, the width to height aspect ratio will be 1.5 (3:2). If the smallest width to height aspect ratio of the pattern feature is less than 2 like this, the feature is often distorted or bent due to pressure application when imprinting, and if less than 1, is more easily distorted.

On the other hand, if the smallest width to height aspect ratio of the pattern feature is greater than two, the feature can be prevented from being bent due to pressure application when imprinting. However, the width of the dummy protrusion 2a being too large causes an increase in production cost and causes the pressing surface in imprinting to be broad, thus decreasing pressure, and hence is not preferable. Because the local pressure of the dummy protrusion 2a decreases in proportion to the protrusion width squared, in order to make pressure difference be within two digits, it is desirable to set the width to height aspect ratio equal to or less than 20, and in order to make pressure difference be within one digit, it is desirable to set the width to height aspect ratio less than 10.

Although in this embodiment the protrusions are guard bands, as long as protrusions are formed at the edges on the inner and outer circumference sides of the data area 1 of the transfer surface of the transfer mold, protrusions may be tracks and recesses may be guard bands. Further, the dummy protrusions 2a, 3a need not be a square having exactly right angles as shown in FIG. 4 but may be in a shape having a little curvature for reasons of production or the like. This also applies to the other embodiments.

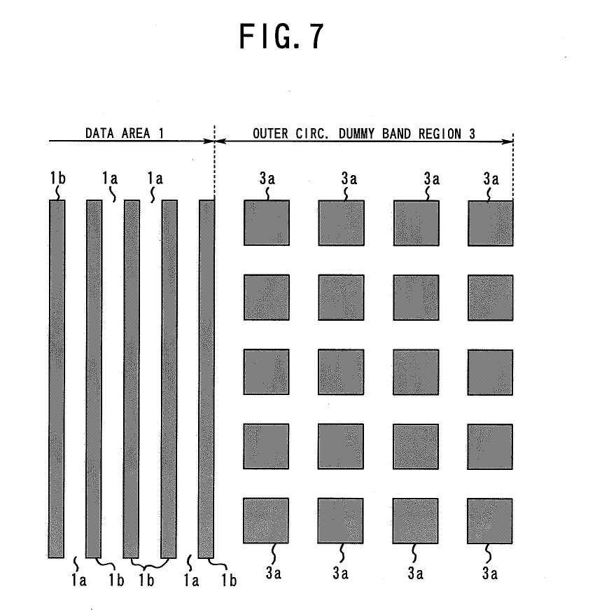

FIG. 7 shows in enlarged view a part of the outer circumference side of the transfer surface of a transfer mold as another embodiment of the present invention. In the transfer surface of the transfer mold of FIG. 7, only four lines of dummy protrusions 3a are formed on an outer circumference dummy band region 3. If the pitch of the dummy protrusions 2a, 3a in a track tangential direction is 2*TP as described above, the pitch of the dummy protrusions 2a, 3a in a disk radial direction is 2*TP. Although four lines of dummy protrusions 3a are shown in FIG. 7, not being limited to this, the number of lines of dummy protrusions 2a, 3a may be another number such as two.

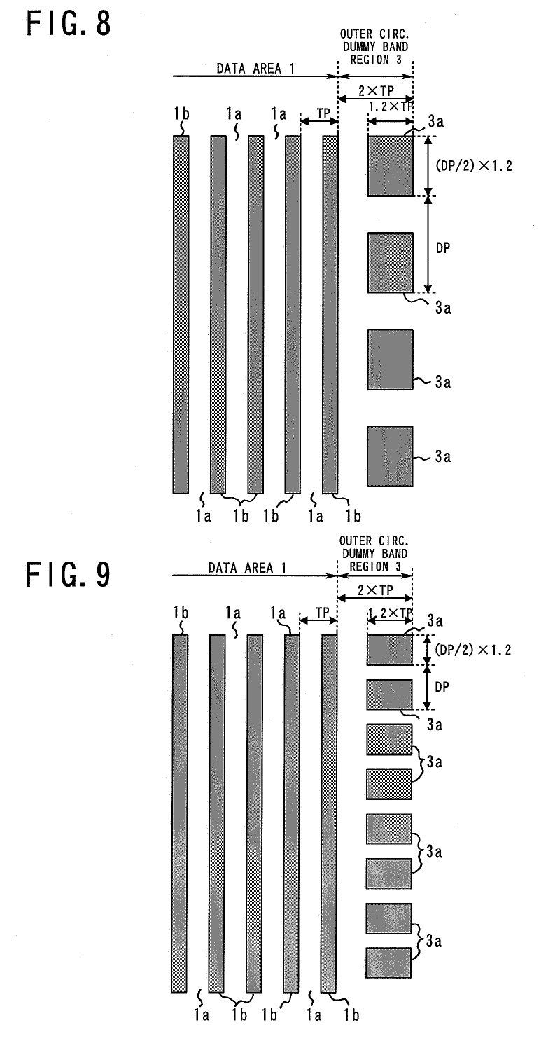

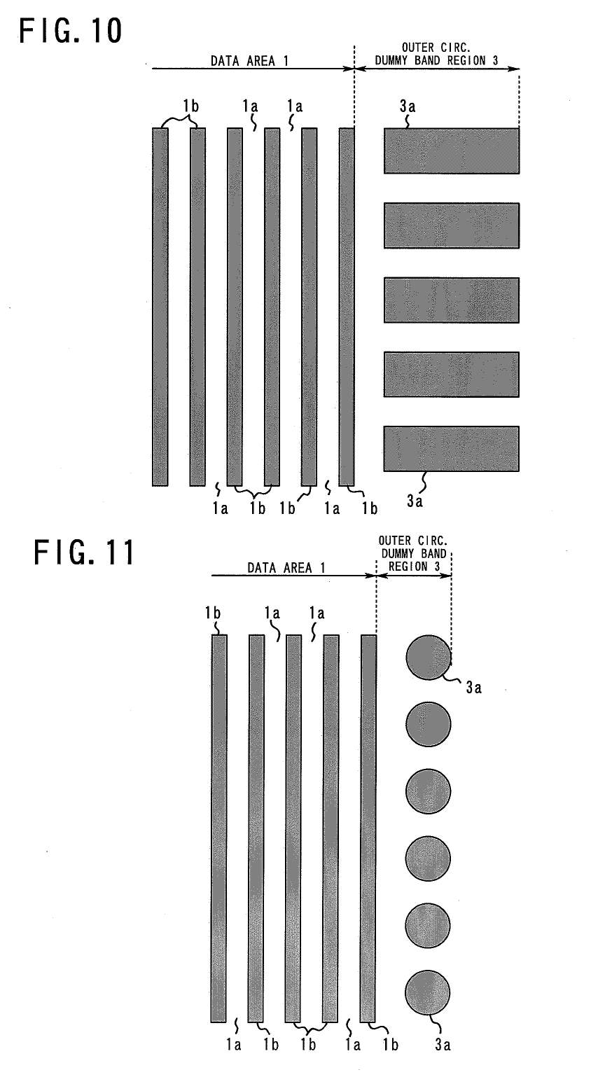

Although the dummy protrusion 3a in FIGS. 3, 4 and 7 is shaped in a square, not being limited to a square, the dummy protrusions 2a, 3a may be in another shape. FIGS. 8 to 10 show cases where the shape of the dummy protrusions 3b is a rectangle. In the case of FIG. 8, assuming that the track pitch of the tracks la is expressed by TP, the length of the short side of the rectangle of the dummy protrusion 3a is 1.2*TP. Assuming that the pitch in the track tangential direction of the dummy protrusions 3a is expressed by DP, the length of the long side of the rectangle of the dummy protrusion 3a is (DP/2)*1.2. In the case of FIG. 9, assuming that the track pitch of the tracks 1a is expressed by TP, the length of the long side of the rectangle of the dummy protrusion 3a is 1.2*TP. Assuming that the pitch in the track tangential direction of the dummy protrusions 3a is expressed by DP, the length of the short side of the rectangle of the dummy protrusion 3a is (DP/2)*1.2. Further, as shown in FIG. 10, the length of the long side of the rectangle of the dummy protrusion 3a, that is, the length in the disk radial direction may be greater than 1.2*TP, but at longest 50 micrometers is enough for it. These arrangement settings of the dummy protrusions 3a also apply to the dummy protrusions 2a.

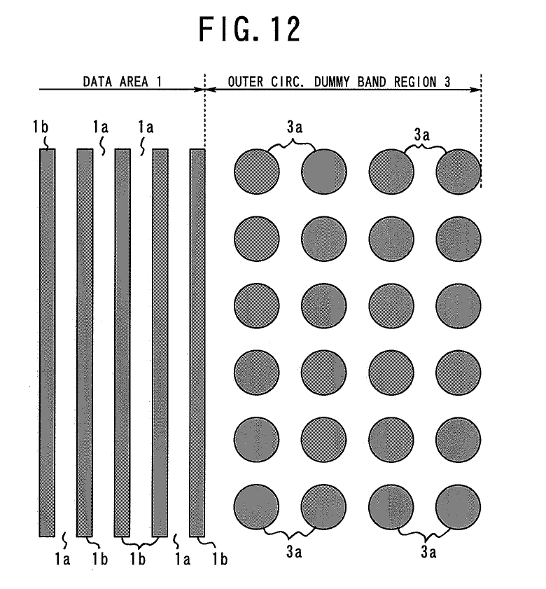

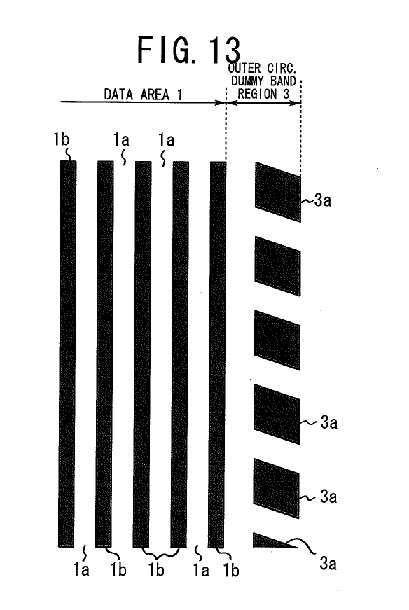

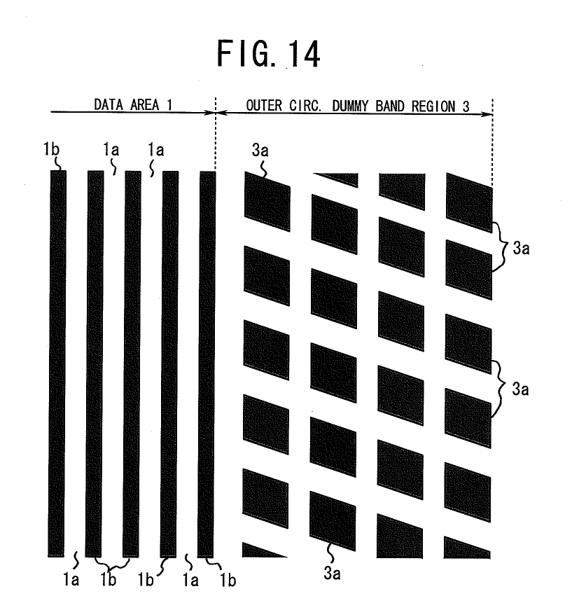

Further, the shape of the dummy protrusions 2a, 3a in the dummy band regions 2, 3, not being limited to a square, may be a circle as shown in FIGS. 11 and 12, or an ellipse or an oval. The shape of the dummy protrusions may be a quadrangle, a parallelogram as shown in FIGS. 13 and 14, or a trapezoid, or of course, may be a polygon such as a hexagon.

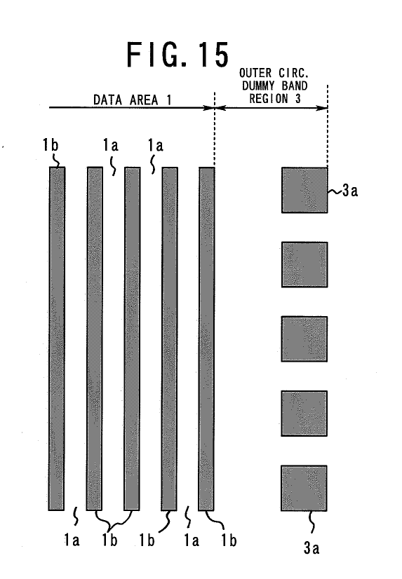

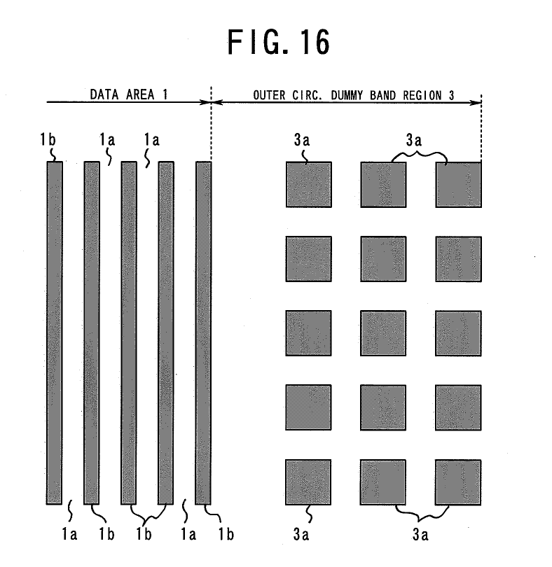

Yet further, the outermost guard band 1b of the data area 1 and the dummy protrusion 3a of the outer circumference dummy band region 3 may be some distance apart as shown in FIGS. 15 and 16. The same applies to between the innermost guard band 1b of the data area 1 and the dummy protrusion 2a of the inner circumference dummy band region 2.

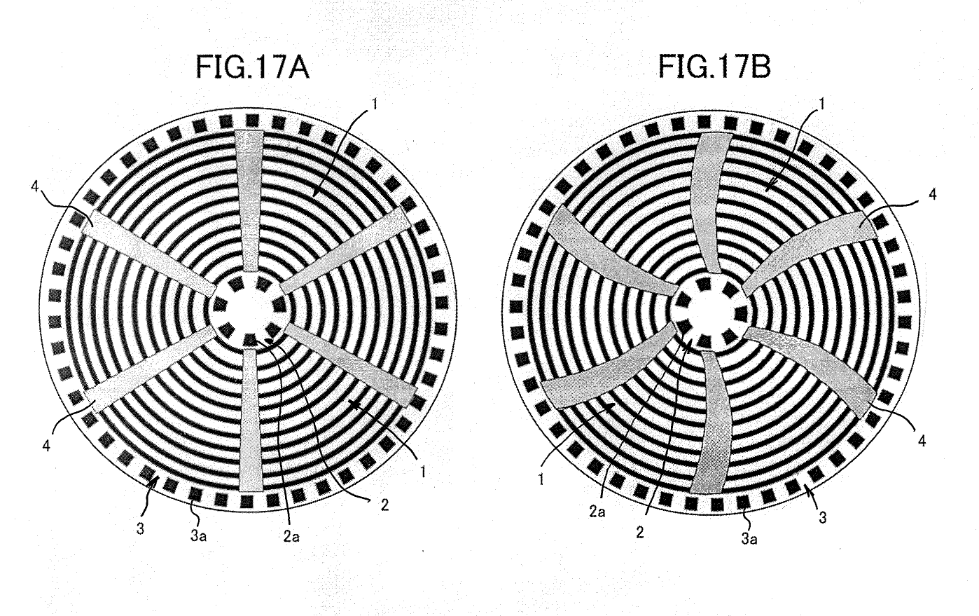

In the above embodiments, the transfer molds where only the data area 1 exists between the inner and outer circumference dummy band regions 2, 3 have been described, but even in the case of a transfer mold having a pattern where data tracks are not continuous because of the presence of servo patterns or the like as shown in, e.g., FIGS. 17A and 17B, the same effect can be obtained by providing the inner and outer circumference dummy band regions 2, 3. In the transfer molds of FIGS. 17A and 17B, where data areas 1 and servo areas 4 having a servo pattern are alternately formed along the circumferential tracks, the inner circumference dummy band region 2 is formed inward of the data areas 1 and the servo areas 4, and the outer circumference dummy band region 3 is formed outward of them. While in the transfer mold of FIG. 17A the boundary between the data area 1 and the servo area 4 is formed straight in the disk radial direction, in the transfer mold of FIG. 17B the boundary between the data area 1 and the servo area 4 is formed to be curved.

Further, not providing both the inner circumference dummy band region 2 and the outer circumference dummy band region 3, either of them may be provided.

Yet further, although in the above embodiments the tracks 1a, the guard bands 1b, and the dummy protrusions 2a, 3a are shaped in concentric rings, the invention is also effective with spiral pattern features.

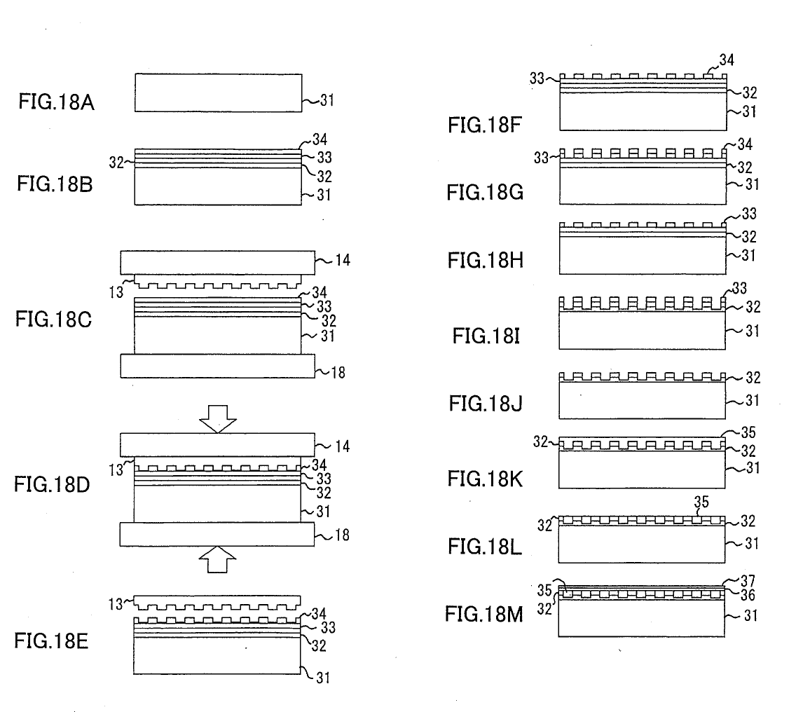

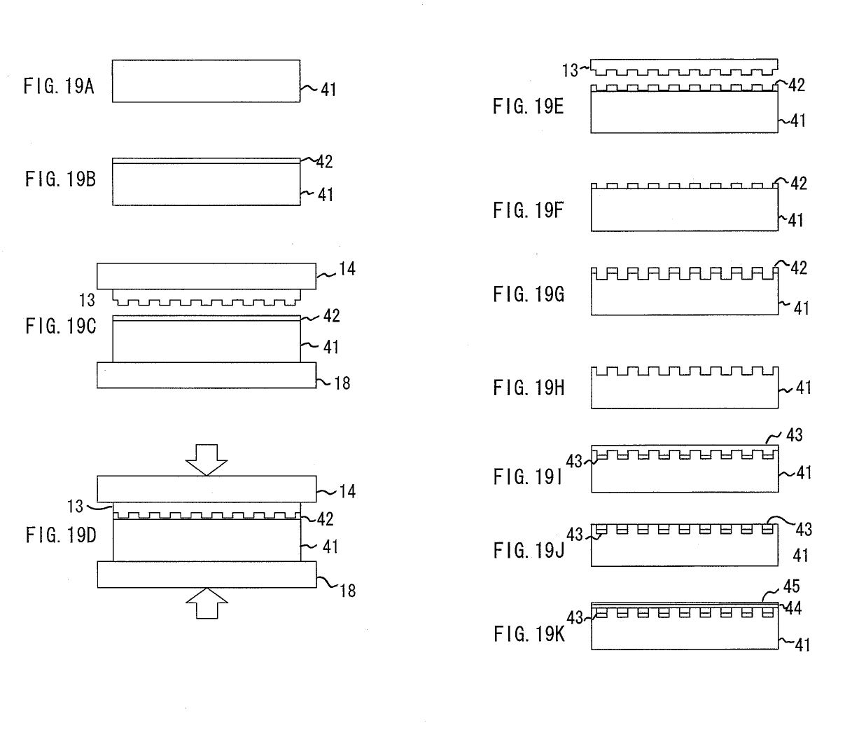

FIGS. 18A to 18M show the process steps of a method of manufacturing magnetic disks by transfer using the transfer mold described above. The base substrate 31 of a magnetic disk shown in FIG. 18A is made of material such as specially-processed chemical tempered glass, a Si wafer, or an aluminum plate. A recording film layer 32 is formed on the base substrate 31 by a process such as sputtering as shown in FIG. 18B. In the case of a vertical magnetic recording medium, the recording film layer 32 is a laminated structure of a soft magnetic underlayer, an intermediate layer, a ferromagnetic recording layer, and the like. On the recording film layer 32, a metal mask layer 33 of Ta, Ti, or the like is formed by a process such as sputtering. On the metal mask layer 33, a resin layer 34 as a mold receiving layer is formed.

The base substrate 31 layered with these layers is secured on the table 18 of the above-described imprinting apparatus as shown in FIG. 18C, whereas the transfer mold 13 is secured with the transfer surface facing downward to the transfer mold holding unit 14. Thus, the surface of the resin layer 34 is set opposite the transfer surface of the transfer mold 13. After the pressure in the operation chamber 12 is decreased by the vacuum pump 15 as needed, it is heated until the resin layer 34 starts to have flowability. Thereafter, as shown in FIG. 18D, when the lifting pressure applying unit 17 lifts the table 18 together with the layered substrate 31, the transfer mold 13 and the resin layer 34 are pressed onto each other by pressure application in the direction indicated by the arrows (the imprinting process). The atmosphere in the operation chamber 12 is returned to the original state, and the lifting pressure applying unit 17 lowers the table 18, so that the transfer mold 13 and the resin layer 34 are separated as shown in FIG. 18E. Thus, the base substrate 31 with the resin layer 34 having the recess/protrusion pattern of the transfer mold 13 transferred therein is obtained.

Unnecessary resin left at the bottoms of the recesses in the resin layer 34 after the imprinting process is removed by soft ashing as shown in FIG. 18F. Then, etching is performed on the substrate 31 (an etching process), in which the remaining portions of the resin layer 34 acting as an etching mask, the exposed portions of the metal mask layer 33 are removed by etching as shown in FIG. 18G.

After the etching process of the metal mask layer 33, the resin of the remaining resin layer 34 is removed by a wet process or oxygen ashing as shown in FIG. 18H. With the remaining portions of the metal mask layer 33 acting as an etching mask, the exposed portions of the recording film layer 32 are removed by dry etching as shown in FIG. 18I. Then the remaining metal mask layer 33 is removed by a wet process or dry etching so that the recess/protrusion surface of the recording film layer 32 is exposed as shown in FIG. 18J. On the recess/protrusion surface of the recording film layer 32, nonmagnetic material 35 is coated filling the recesses by sputtering or coating as shown in FIG. 18K.

The surface of the nonmagnetic material 35 coated is polished by etch back or chemical mechanical polishing to be flattened as shown in FIG. 18L. Thereby, a structure is formed in which protrusions of the recording film layer 32 are separated by the nonmagnetic material 35, non-recording material. On the flattened surface, a protective film 36 and a lubricant film 37 are formed by, e.g., sputtering or dipping to finish a magnetic disk as shown in FIG. 18M. The magnetic disk is incorporated in a hard disk drive to form a discrete track medium or a patterned medium.

FIGS. 19A to 19K show the process steps of another method of manufacturing magnetic disks by transfer using the transfer mold described above. The base substrate 41 of a magnetic disk shown in FIG. 19A is made of nonmagnetic material such as specially-processed chemical tempered glass, a Si wafer, or an aluminum plate. A resin layer 42 as transferred-to material is formed on the base substrate 41 as shown in FIG. 19 B.

The base substrate 31 having this resin layer 42 is secured on the table 18 of the above-described imprinting apparatus as shown in FIG. 19C, whereas the transfer mold 13 is secured with the transfer surface facing downward to the transfer mold holding unit 14. Thus, the surface of the resin layer 42 is set opposite the transfer surface of the transfer mold 13. After the pressure in the operation chamber 12 is decreased by the vacuum pump 15 as needed, it is heated until the resin layer 42 starts to have flowability. Thereafter, as shown in FIG. 19D, when the lifting pressure applying unit 17 lifts the table 18 together with the layered substrate 41, the transfer mold 13 and the resin layer 42 are pressed onto each other by pressure application in the direction indicated by the arrows (the imprinting process). The atmosphere in the operation chamber 12 is returned to the original state, and the lifting pressure applying unit 17 lowers the table 18, so that the transfer mold 13 and the resin layer 42 are separated as shown in FIG. 19E. Thus, the base substrate 41 with the resin layer 42 having the recess/protrusion pattern of the transfer mold 13 transferred therein is obtained.

Unnecessary resin left at the bottoms of the recesses in the resin layer 42 after the imprinting process is removed by soft ashing as shown in FIG. 19F. Then, etching is performed on the substrate 41 (an etching process), in which the remaining portions of the resin layer 42 acting as an etching mask, the exposed portions of the substrate 41 are removed by etching to form recesses therein as shown in FIG. 19G.

After the etching process of the substrate 41, the resin of the remaining resin layer 42 is removed by a wet process or dry etching so that the recess/protrusion surface of the substrate 41 is exposed as shown in FIG. 19H. On the recess/protrusion surface of the substrate 41, a recording film layer 43 of magnetic material is formed filling the recesses by a technique such as sputtering as shown in FIG. 19I. In the case of a vertical magnetic recording medium, the recording film layer 43 is a laminated structure of a soft magnetic underlayer, an intermediate layer, a ferromagnetic recording layer, and the like.

The surface of the recording film layer 43 formed is polished by etch back or chemical mechanical polishing to be flattened as shown in FIG. 19J. Thereby, a structure is formed in which the remaining portions of the recording film layer 43 are separated by the non-recording material of the substrate 41. On the surface of the flattened recording film layer 43, a protective film 44 and a lubricant film 45 are formed by, e.g., sputtering or dipping to finish a magnetic disk as shown in FIG. 19K.

As described above, according to the present invention, a line of multiple dummy protrusions that have a width in a disk radial direction of no less than the track pitch of the data track pattern is formed in the dummy band regions of the transfer mold, and hence the pattern features in the dummy band regions of the transfer mold can be prevented from being distorted when the transfer mold is pressed onto the resin layer on the substrate surface by an imprinting apparatus. Therefore, the patterns of the dummy band regions as well as of the data area can be reliably formed in the resin layer without deformation.

### INDUSTRIAL AVAILABILITY

The present invention can be applied to near-field optical recording media, SIL, holographic memories, super-resolution optical discs, multilayer optical discs, and next-generation disk recording media as well as magnetic recording media such as discrete track media and patterned media.

1. A transfer mold for manufacturing a recording medium by imprinting, having a transfer surface on which a data area having a data track pattern for a disk-shaped recording medium and a dummy area having a dummy pattern in an outward portion and/or an inward portion of said data area are formed,
wherein said dummy pattern includes at least one line of a plurality of dummy protrusions that have a width in a disk radial direction of no less than a track pitch of said data track pattern, and
a ratio of a smallest width to a height of said dummy protrusion (=smallest width/height) is 2 to 20.

2. The recording medium manufacturing transfer mold according to claim 1, wherein a top surface shape of each of said dummy protrusions is a polygon or a circle including an ellipse.

3. (canceled)

4. The recording medium manufacturing transfer mold according to claim 1, wherein the line of said dummy protrusions is a circular line.

5. The recording medium manufacturing transfer mold according to claim 1, wherein said dummy area has a width of no greater than 50 micrometers in the disk radial direction.

6. The recording medium manufacturing transfer mold according to claim 1, wherein a ratio of an area of said dummy protrusions to an area other than said dummy protrusions in said dummy area is substantially equal to a ratio of an area of protrusions to an area other than the protrusions in said data area.

7. A recording medium manufacturing method of pressing onto a mold receiving layer formed on a surface of a recording medium substrate a transfer surface of a recording medium manufacturing transfer mold which has the transfer surface on which a data area having a data track pattern for a disk-shaped recording medium and a dummy area having a dummy pattern in an outward portion and/or an inward portion of said data area are formed, to transfer said data track pattern and said dummy pattern into said mold receiving layer,
wherein said dummy pattern includes at least one line of a plurality of dummy protrusions that have a width in a disk radial direction of no less than a track pitch of said data track pattern, and
a ratio of a smallest width to a height of said dummy protrusion (=smallest width/height) is 2 to 20.

8. A recording medium produced in accordance with a data track pattern and a dummy pattern transferred in a mold receiving layer formed on a surface of a recording medium substrate by pressing onto said mold receiving layer a transfer surface of a recording medium manufacturing transfer mold which has the transfer surface on which a data area having a data track pattern for a disk-shaped recording medium and a dummy area having a dummy pattern in an outward portion and/or an inward portion of said data area are formed,
wherein said dummy pattern including at least one line of a plurality of dummy protrusions that have a width in a disk radial direction of no less than a track pitch of said data track pattern, and
a ratio of a smallest width to a height of said dummy protrusion (=smallest width/height) is 2 to 20.
